(19) United States
(12) Patent Application Publication
(10) Pub. No.: US 2008/0147304 A1
(43) Pub. Date: Jun. 19, 2008

(54) Key system for a motor vehicle, data transfer system for a motor vehicle and method for transferring data to or from a motor vehicle

(75) Inventors: Derek Pai, San Francisco, CA (US); Carsten Bergmann, San Jose, CA (US); Chu Hee Lee, San Jose, CA (US); Philippe Alessandrini, Palo Alto, CA (US)

Correspondence Address: MANFRED BECK, P.A., 830 TYLER STREET, HOLLYWOOD, FL, 33019-1327, US

(73) Assignee: Volkswagen of America, Inc., Auburn Hills, MI (US)

(21) Appl. No.: 11/640,025

(22) Filed: Dec. 15, 2006

(51) Int. Cl. G06F 19/00

(52) U.S. Cl. 701/115

(57) ABSTRACT

A key for a motor vehicle includes an access module for unlocking or opening a door of the motor vehicle or for starting the motor vehicle. The key has a memory module for storing user data and a data transfer module for a wireless access to the memory module. The memory module is a rewritable memory module which can be removed by a user. A data transfer system for a motor vehicle and a method for transferring data to or from a motor vehicle are also provided.

### BACKGROUND OF THE INVENTION

### Field of the Invention

The invention relates to a key system for a motor vehicle having a key with an access module for unlocking and/or opening a door of the motor vehicle and/or for starting the motor vehicle. The invention further relates to a data transfer system for a motor vehicle and a method for transferring data to or from a motor vehicle.

German Utility Model No. DE 91 03 374 U1 discloses a vehicle key having at least one integrated data memory which can store and output vehicle-specific data and/or freely selectable code words. The data memory is provided in the key housing and can be closed with a cover.

A further motor vehicle key is disclosed on the website www.schmeiler.net/projekte/fahrzeug/ef804695d40e0e601.html. Via the key's plug connection with the ignition lock it is possible to provide a power supply and a data transfer. A read or play device makes it possible to read out or listen to the data (e.g. songs) outside the vehicle. The read or play device has its own power supply and also supplies electric power to the motor vehicle key. The read or play device can communicate with a PC (Personal Computer) via a wireless connection known under the trademark name BLUETOOTH or via a USB (Universal Serial Bus) connection.

German Patent Application Publication No. DE 199 19 501 A1 discloses a device for storing operation-dependent vehicle data such as an odometer reading, a tank level, an average consumption or similar data in a memory element. The vehicle data can be made available outside the vehicle. For example, the vehicle data can be made available to a fleet management system. An electronic display unit provided in the vehicle and an immobilizer are coupled to one another with an inductive data transfer between the vehicle and the ignition key such that the data, which are present in the display unit, are transferred through the use of the inductive coupling between the vehicle and the key and are stored in a memory element in the key.

German Patent No. DE 195 13 498 C1 discloses an electronic vehicle key having a speech memory, a speech output unit and a control unit with a speech system function. By using the speech system function for example the parking spot of a vehicle can be stored in the key and can be output again as a speech output. A key equipped with a radio call reception function allows the transmission of radio call messages to the owner of the key.

Further keys for motor vehicles are disclosed in German Patent Application Publication No. DE 199 17 817 A1 and in German Patent Application Publication No. DE 102 44 001 A1.

Some motor vehicles sold by the AUDI corporation have a slot into which a memory card can be inserted for reading out data of the memory card.

### SUMMARY OF THE INVENTION

It is an object of the invention to provide a key system for a motor vehicle, a data transfer system for a motor vehicle and a method for transferring data to or from a motor vehicle which overcome disadvantages of the heretofore-known methods and devices of this general type, which improve a data transfer with regard to a motor vehicle, which provide a robust data transfer with regard to a motor vehicle, and which reduce the cost of manufacturing a motor vehicle.

With the foregoing and other objects in view there is provided, in accordance with the invention, a key system for a motor vehicle, including:

a key having a memory module, an access module, and a data transfer module;
the memory module being a rewritable, user-removable memory module for storing user data;
the access module being configured to perform at least one function selected from the group consisting of unlocking a motor vehicle door, opening a motor vehicle door, and starting a motor vehicle; and
the data transfer module being configured to provide wireless access to the memory module.

In other words, according to the invention, there is provided a key for a motor vehicle wherein the key includes:

an access module for unlocking and/or opening a door of the motor vehicle and/or for starting the motor vehicle;
a memory module for storing user data, wherein the memory module is a rewritable memory module and wherein the memory module can be removed by a user; and
a data transfer module for a wireless access to the memory module.

An access module in accordance with the invention can be embodied mechanically and/or electronically. An access module in accordance with the invention may for example be a key and/or an electronic access to an electronic locking system. User data in accordance with the invention may for example be data for an infotainment system and/or data for a navigation system. In the course of a wireless access to the memory module it may be provided that a wireless access to data stored by the memory module is possible and/or that data for storage in the memory module are transferred wirelessly to the key. A user-removable memory module in accordance with the invention, i.e. a memory module which is removable by a user, is in particular a memory module that can be removed without effort by the user. A user-removable memory module in accordance with the invention is in particular a memory module that can be removed without the use of tools by the user.

In accordance with an embodiment of the invention, the memory module is an SD (Secure Digital) memory card. In accordance with another embodiment of the invention, data for an infotainment module and/or data for a navigation system are stored in the memory module.

In accordance with another embodiment of the invention, the memory module is disposed in a housing of the key. In this case, in accordance with a further embodiment of the invention, the key has an opening or slot for receiving the memory module, wherein a cover is provided on the housing for closing the opening.

The key may additionally include a memory that is fixedly connected to the key. It may be provided that data stored in this memory are transferred via the same interface of the key via which the data stored in the memory module are transferred.

In accordance with another feature of the invention, the memory module stores infotainment data to be used by an infotainment system and/or navigation data to be used by a navigation system.

In accordance with yet another feature of the invention, the key has a housing; and the memory module is disposed in the housing.

In accordance with a further feature of the invention, the key has an opening formed therein, the opening is configured to receive the memory module; and the housing has preferably a cover for closing the opening.

In accordance with the invention, there is also provided a data transfer system, including:

a motor vehicle having a door;
a key configured to perform at least one function selected from the group consisting of unlocking the door of the motor vehicle, opening the door of the motor vehicle and starting the motor vehicle;
the key having a rewritable, user-removable memory module configured to store user data;
the motor vehicle and the key being configured to establish a wireless communications connection between one another such that the motor vehicle has access to the memory module; and
a computer, the computer and the key being configured to establish a wireless communications connection between one another such that the computer has access to the memory module.

In other words, according to the invention, there is provided a data transfer system for a motor vehicle that includes a key, which has in particular one or more of the above-mentioned features, for unlocking and/or opening a door of the motor vehicle and/or for starting the motor vehicle, wherein the key includes a memory module for storing user data that can be removed by a user, wherein the memory module is rewritable, wherein the data transfer system includes a motor vehicle and a computer, in particular a computer that is spatially separated from the motor vehicle, wherein a wireless communications connection can be established between the motor vehicle and the key for an access to the memory module by the motor vehicle, and wherein a wireless communications connection can be established between the computer and the key for an access to the memory module by the computer.

A computer in accordance with the invention is in particular a computing device or external electronics device. A computer in accordance with the invention is in particular a PC (personal computer), a desktop computer, a laptop computer, a notebook computer, a PDA (personal digital assistant), a cell phone, a digital camera, another motor vehicle or similar devices.

In accordance with an embodiment of the invention, the memory module is an SD (Secure Digital) memory card. In accordance with another embodiment of the invention, data for an infotainment module and/or data for a navigation system are stored in the memory module.

In accordance with another embodiment of the invention, the memory module is disposed in a housing of the key. In accordance with a further embodiment of the invention, the key has in this case an opening for receiving the memory module wherein a cover for closing the opening is provided at the housing.

The key may additionally include a memory that is fixedly connected to the key. It may be provided that data stored in this memory are transferred via the same interface of the key via which the data stored in the memory module are transferred.

In accordance with the invention, there is further provided a method for transferring data to a motor vehicle, wherein the method includes the steps of:

providing a key configured to perform at least one function selected from the group consisting of unlocking a door of a motor vehicle, opening a door of the motor vehicle and starting the motor vehicle;
providing a rewritable, removable memory module;
inserting or placing the memory module in the key;
transferring data from a computer to the memory module;
starting the motor vehicle with the key; and
wirelessly transferring the data from the memory module to the motor vehicle.

In other words, according to the invention, there is provided a method for transferring data to a motor vehicle, wherein a rewritable and removable memory module is inserted or placed in a key for unlocking and/or opening a door of the motor vehicle and/or for starting the motor vehicle, which key has in particular one or more of the above-mentioned features, wherein the data are transferred from a computer to the memory module, wherein the motor vehicle is started by the key, and wherein the data are wirelessly transferred from the memory module to the motor vehicle.

In accordance with the invention, there is further provided a method for transferring data from a motor vehicle, that includes the steps of:

providing a key configured to perform at least one function selected from the group consisting of unlocking a door of a motor vehicle, opening a door of the motor vehicle and starting the motor vehicle;
providing a rewritable, removable memory module;
inserting or placing the memory module in the key;
wirelessly transferring data from the motor vehicle to the memory module; and
wirelessly transferring the data from the memory module to a computer.

In other words, according to the invention, there is provided a method for transferring data from a motor vehicle, wherein a rewritable and removable memory module is inserted or placed in a key for unlocking and/or opening a door of the motor vehicle and/or for starting the motor vehicle, which key has in particular one or more of the above-mentioned features, wherein the data are wirelessly transferred from the motor vehicle to the memory module, wherein the motor vehicle is started by the key, and wherein the data are wirelessly transferred from the memory module to a computer.

A motor vehicle in accordance with the invention is in particular a land vehicle which is operated individually in road traffic. Motor vehicles for the purpose of the invention are in particular not limited to land vehicles having a combustion engine.

Although the invention is illustrated and described herein as embodied in a key system and a data transfer system as well as a data transfer method for a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic overview of an exemplary embodiment of a data transfer system for a motor vehicle in accordance with the invention;

FIG. 2 is a diagrammatic perspective view of an exemplary embodiment of a key for a motor vehicle in accordance with the invention;

FIG. 3 is a detailed basic representation of the key of FIG. 2 in accordance with the invention;

FIG. 4 is a further detailed basic representation of the key of FIG. 2 in accordance with the invention; and

FIG. 5 is a flow chart illustrating an exemplary mode of a method for transferring data in accordance with the invention.

### DESCRIPTION OF THE PREFERRED EMBODIMENTS

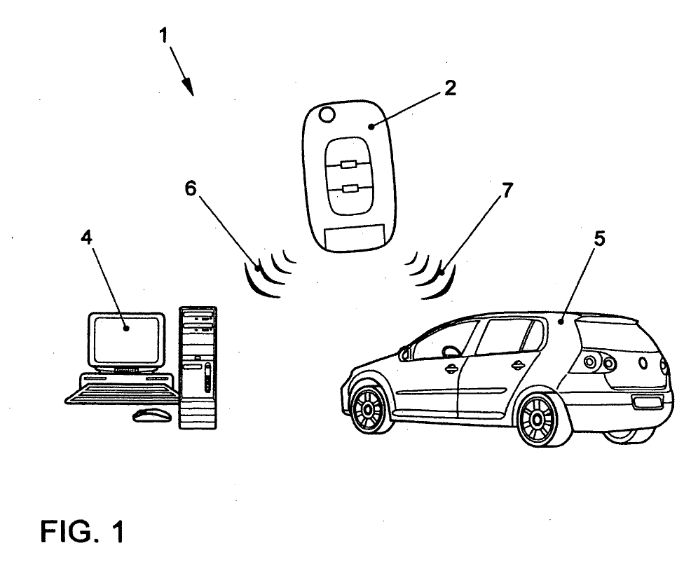

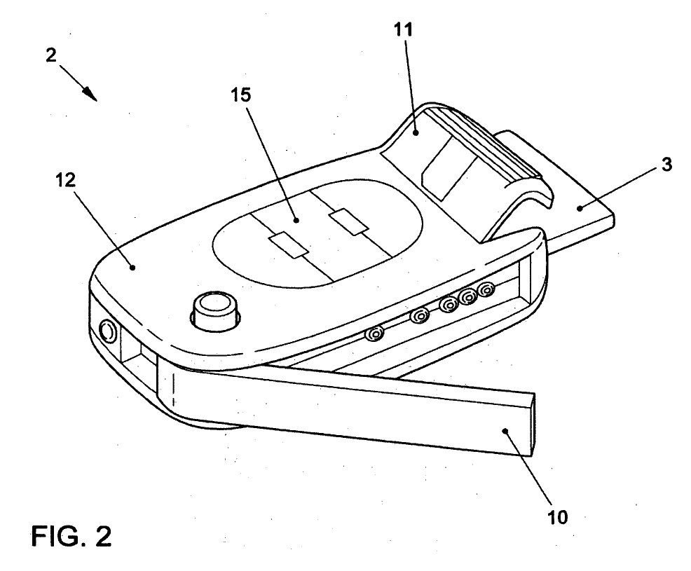

Referring now to the figures of the drawings in detail and first, particularly, to FIG. 1 thereof, there is shown an exemplary embodiment of a data transfer system 1 for a motor vehicle 5. The data transfer system 1 includes a key 2, which is illustrated in detail in FIG. 2, for unlocking and/or opening a door of the motor vehicle 5 and/or for starting the motor vehicle 5. Through the use of the key 2, data such as data for an infotainment system and/or data for a navigation system can be transferred from a computer 4, i.e. an external electronics device, to the motor vehicle 5 and/or from the motor vehicle 5 to the computer 4 via a wireless communications connection 6 (e.g. BLUETOOTH) between the computer 4 and the key 2 and via a wireless communications connection 7 (e.g. BLUETOOTH) between the key 2 and the motor vehicle 5. The wireless communications connections 6 and 7 are short-range connections. The wireless communications connections 6 and 7 can be RF (radio frequency) connections or IR (infrared) connections.

The key 2 includes a housing 12. The housing 12 includes an opening for receiving a memory module 3 and a cover 11 for closing the opening. In the present exemplary embodiment, the memory module 3 is embodied as an SD (Secure Digital) memory card. FIG. 2 shows the cover 11 in an opened state. The memory module 3 in FIG. 2 is partially inserted in the opening. When the memory module 3 is completely inserted into the opening and the cover 11 is closed, the memory module is completely enclosed by the housing 12 and is protected against damage. The key 2 furthermore includes a mechanical key 10 for mechanically unlocking a door of the motor vehicle 5 and/or for mechanically starting the motor vehicle 1. The key 2 also includes operating elements 15 for electronically unlocking and/or opening a door of the motor vehicle 1. The mechanical key 10 is pivotably connected to the housing 12. The mechanical key 10 is an exemplary embodiment of an access module as defined in the claims. The operating elements 15 are part of the exemplary embodiment for an access module in accordance with the claims.

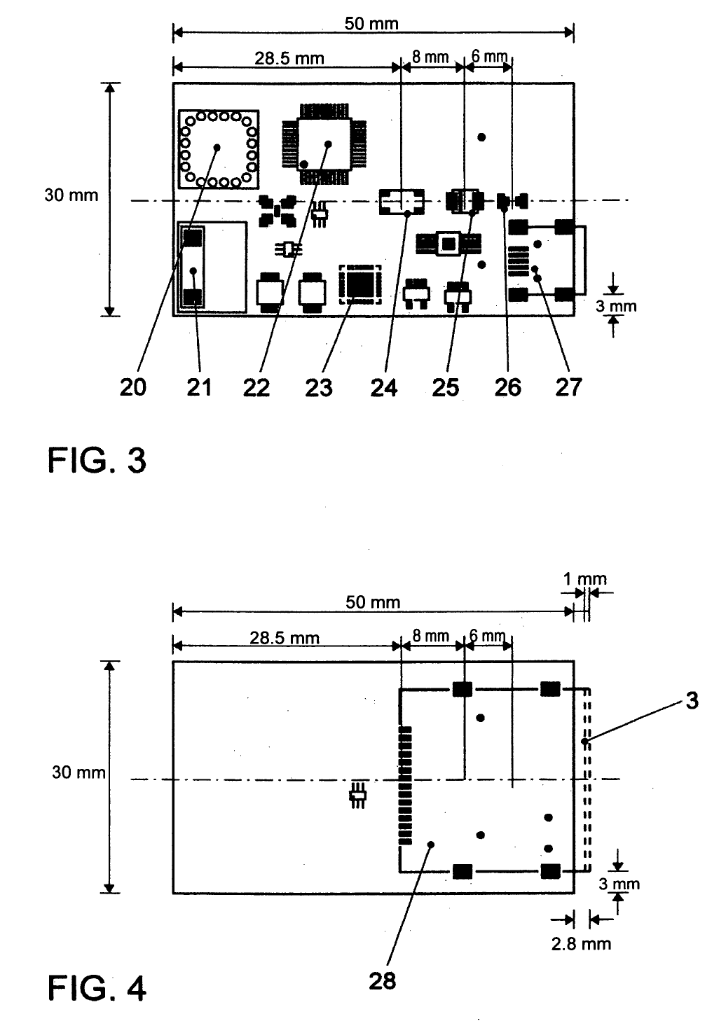

FIG. 3 shows a top view of internal components of the key 2 in a detailed basic representation. Approximate dimensions are shown in millimeters. Reference numeral 20 denotes a data transfer module and reference numeral 21 denotes an antenna which is assigned to the data transfer module 20. Through the use of the data transfer module 20 and the assigned antenna 21 it is for example possible to establish a BLUETOOTH connection. Reference numeral 22 denotes a microprocessor and reference numeral 23 denotes a memory fixedly connected to the key 2. The memory 23 can be provided for example for storing an access code or operation-dependent vehicle data such as an odometer reading, a tank level and/or an average consumption, as is for example disclosed in German Patent Application Publication No. DE 199 19 501 A1. The key 2 furthermore includes an operating-element interface 24 for the operating elements 15 and a status LED (light emitting diode) 25. Reference numeral 27 denotes a connector for a power supply and reference numeral 26 denotes an LED for indicating that the battery of the key 2 is being charged.

FIG. 4 shows a bottom view of internal components of the key 2 in a detailed basic representation. Reference numeral 28 denotes the opening or slot 28 for receiving the memory module 3. An SD card reader is assigned to the opening 28. The data transfer module 20 and the associated antenna 21 form an interface of the key 2, wherein data stored in the memory 23 as well as data stored in the memory module 3 can be transferred via the interface.

The motor vehicle 5 includes an interface for the wireless communications connection 7 (e.g. BLUETOOTH) including corresponding software as well a man-machine interface and software for accessing and using the data stored in the memory module 3.

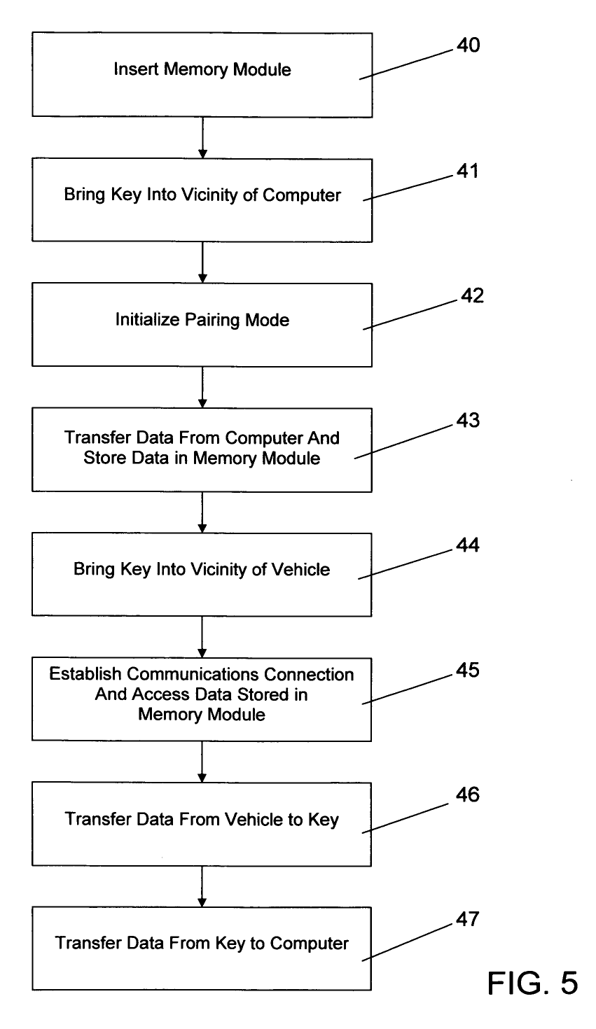

FIG. 5 shows an exemplary mode of a method for transferring data and, respectively, a method for operating the data transfer system 1. In accordance with this method, in a step 40, the memory module 3 is placed or inserted into the opening 28. In a step 41, the key 2 is brought into the vicinity of the computer 4. In a subsequent step 42, a so-called pairing mode is initialized by pressing an operating element of the key 2. After that, in a step 43, a user of the key 2 can transfer data via the communications connection 6 from the computer 4 to the key 2 and store the data in the memory module 3.

In a subsequent step 44, the key 2 is brought into the vicinity of the motor vehicle 5 and the motor vehicle 5 is started through the use of the mechanical key 10 or by pressing a starter button. Following step 44 is step 45 in which the motor vehicle 5 establishes the communications connection 7 on its own. Now a user can access the data which are stored on the memory module 3. In this way, it is for example possible to play music, to access e-mails, contacts and appointments, to view pictures and so forth. Furthermore, it is possible to transfer firmware updates to the motor vehicle 5, which have been downloaded from the internet and have been transferred to the memory module 3.

In a subsequent step 46, vehicle data such as an odometer reading, a tank level, an average fuel consumption, service information, personal comfort and convenience settings and trip information can be transferred from the vehicle 5 to the key 2. In a subsequent step 47, which includes steps 41 and 42, these data can be transferred from the key 2 to the computer 4. There may also be provisions for transferring these data in part over the internet to a service center.

List of Reference Numerals:

| | |
|---|---|
| 1 | data transfer system |
| 2 | key for motor vehicle |
| 3 | memory module |
| 4 | computer |
| 5 | motor vehicle |
| 6, 7 | communications connection |
| 10 | mechanical key |
| 11 | cover |
| 12 | housing |
| 15 | operating elements |
| 20 | data transfer module |
| 21 | antenna |
| 22 | microprocessor |
| 23 | memory fixedly connected to key |
| 24 | operating-element interface |
| 25 | status LED |
| 26 | LED |
| 27 | connector for power supply |
| 28 | opening (slot) |
| 40, 41, 42, 43 | step |
| 44, 45, 46, 47 | step |

We claim:

1. A key system for a motor vehicle, comprising:
a key having a memory module, an access module, and a data transfer module;
said memory module being a rewritable, user-removable memory module for storing user data;
said access module being configured to perform at least one function selected from the group consisting of unlocking a motor vehicle door, opening a motor vehicle door, and starting a motor vehicle; and
said data transfer module being configured to provide wireless access to said memory module.

2. The key system according to claim 1, wherein said memory module is an SD memory card.

3. The key system according to claim 1, wherein said memory module stores infotainment data to be used by an infotainment system.

4. The key system according to claim 1, wherein said memory module stores navigation data to be used by a navigation system.

5. The key system according to claim 1, wherein:
said key has a housing; and
said memory module is disposed in said housing.

6. The key system according to claim 5, wherein:
said key has an opening formed therein, said opening is configured to receive said memory module; and
said housing has a cover for closing said opening.

7. The key system according to claim 1, wherein said key has an opening formed therein, and said opening is configured to receive said memory module.

8. The key system according to claim 7, wherein said key has a cover for closing said opening formed in said key.

9. A data transfer system, comprising:
a motor vehicle having a door;
a key configured to perform at least one function selected from the group consisting of unlocking said door of said motor vehicle, opening said door of said motor vehicle and starting said motor vehicle;
said key having a rewritable, user-removable memory module configured to store user data;
said motor vehicle and said key being configured to establish a wireless communications connection between one another such that said motor vehicle has access to said memory module; and
a computer, said computer and said key being configured to establish a wireless communications connection between one another such that said computer has access to said memory module.

10. The data transfer system according to claim 9, wherein said memory module is an SD memory card.

11. The data transfer system according to claim 9, wherein said memory module stores infotainment data to be used by an infotainment system.

12. The data transfer system according to claim 9, wherein said memory module stores navigation data to be used by a navigation system.

13. The data transfer system according to claim 9, wherein:
said key has a housing; and
said memory module is disposed in said housing.

14. The data transfer system according to claim 13, wherein:
said key has an opening formed therein, said opening is configured to receive said memory module; and
said housing has a cover for closing said opening.

15. The data transfer system according to claim 9, wherein said key has an opening formed therein, said opening is configured to receive said memory module.

16. The data transfer system according to claim 15, wherein said key has a cover for closing said opening formed in said key.

17. A method for transferring data to a motor vehicle, the method which comprises:
providing a key configured to perform at least one function selected from the group consisting of unlocking a door of a motor vehicle, opening a door of the motor vehicle and starting the motor vehicle;
providing a rewritable, removable memory module;
one of inserting and placing the memory module in the key;
transferring data from a computer to the memory module;
starting the motor vehicle with the key; and
wirelessly transferring the data from the memory module to the motor vehicle.

18. A method for transferring data from a motor vehicle, the method which comprises:
providing a key configured to perform at least one function selected from the group consisting of unlocking a door of a motor vehicle, opening a door of the motor vehicle and starting the motor vehicle;
providing a rewritable, removable memory module;
one of inserting and placing the memory module in the key;
wirelessly transferring data from the motor vehicle to the memory module; and
wirelessly transferring the data from the memory module to a computer.
